(19) United States
(12) Patent Application Publication
(10) Pub. No.: US 2018/0362739 A1
(43) Pub. Date: Dec. 20, 2018

(54) FORMULA FOR PRODUCING TREAD STOCK

(71) Applicant: TAIWAN CARBON NANO TECHNOLOGY CORPORATION, MIAOLI COUNTY (TW)

(72) Inventors: Chia-Hung Li, MIAOLI COUNTY (TW); Chao-Chieh Lin, MIAOLI COUNTY (TW); Ching-Tung Hsu, MIAOLI COUNTY (TW); Chun-Hsien Tsai, MIAOLI COUNTY (TW); Ting-Chuan Lee, MIAOLI COUNTY (TW); Chun-Jung Tsai, MIAOLI COUNTY (TW)

(21) Appl. No.: 16/006,034

(22) Filed: Jun. 12, 2018

(30) Foreign Application Priority Data
Jun. 14, 2017 (TW) 106119779

(51) Int. Cl. C08L 9/06; C08K 3/04; C08K 3/22; C08K 5/09; B60C 1/00

(52) U.S. Cl. CPC C08L 9/06; C08K 3/04; C08K 3/22; C08K 2003/2296; C08K 3/041; B60C 1/0016; C08K 2201/011; C08K 5/09

(57) ABSTRACT

The present invention provides a formula for producing tread stock, wherein the formula for producing tread stock comprises a silicone rubber; a carbon material accounting for 0.005% to 0.02% by weight of total components; a filler accounting for 10% to 75% by weight of the total components; and a cross-linking agent accounting for 0.5% to 2% by weight of the total components. The above-mentioned formula for producing tread stock has the advantages of excellent abrasion resistance and prolonged lifetime.

### FIELD OF THE INVENTION

The present invention relates to a formula for producing an elastic composite material, in particular to a formula for producing tread stock.

### BACKGROUND OF THE INVENTION

Elastic materials are widely used in various industrial and people's livelihood fields from automotive tires, shoes, adhesive tapes, sports goods, floors, conveying belts, and other daily necessities, to electronics, semiconductor industries, space parts and other precision industries, there are demands for them. There are also many kinds of the elastic materials, such as nitrile rubber, silicone rubber, fluoro carbon rubber, styrene-butadiene rubber and the like.

Among them, taking rubber as an example, the composition and the formula have a variety of current forms after many evolutions, improvements, and developments: Initially, natural rubber was collected from rubber trees. Then the natural rubber were improved by utilizing a rubber vulcanization method. Later, coal, oil, and natural gas were used as main raw materials, and various types of synthetic rubber were produced in an artificial manner according to the demands. However, due to the different formula compositions, these rubber products have unique physical properties.

For example, a rubber composition disclosed in the U.S. Pat. No. 9,228,077B2 comprises a rubber component (A), a farnesene polymer (B), and silica (C), and the content of the polymer in the rubber composition is 1 to 100 parts by weight. The tire produced by using the rubber composition of the patent has excellent rolling resistance and can suppress decreases in mechanical strength and hardness; or a vulcanizable rubber mixture as disclosed in the U.S. Pat. No. 9,593,228 B2 comprises: (A) at least one diene rubber functionalized with carboxyl groups and/or hydroxyl groups and/or salts thereof; (B) at least one pale-coloured filler; (C) trimethylolpropane; (D) at least one fatty acid. Wherein based on 100 parts by weight of the component (A), the sum of the amounts of the components (C) and (D) is 0.1 to 20 parts by weight, and the vulcanizable rubber mixture can be applied to tire treads of vehicles and has the advantages of high abrasion resistance, low rolling resistance and the like.

However, the pursuit of quality is often endless. Particularly, most elastic materials are often faced with abrasion problems during the use, and are prone to aging as the use time increases. All of the above-mentioned problems are still the issues which are urgent to improve and breakthrough by the research team at present.

### SUMMARY OF THE INVENTION

A main objective of the present invention is to overcome the disadvantages that the conventional silicone rubber is dissatisfactory durability and prone to aging and deterioration as the time goes by.

In order to achieve the above-mentioned objective, the present invention provides a formula for producing an elastic composite material, a product comprising the same and a tread stock, so as to enable the product produced according to the formula to have the advantages of being more abrasion-resistant and more aging-resistant, and further prolong the lifetime of the product.

Accordingly, the present invention provides an elastic composite material, comprising a silicone rubber and a carbon material which is dispersed in the silicone rubber and accounts for 0.0005% to 0.099% by weight of the total components, wherein the carbon material is selected from the group consisting of single-walled carbon nanotubes, multi-walled carbon nanotubes, graphene, graphene oxide and combinations thereof.

The present invention further provides an elastic composite material, comprising a silicone rubber; a carbon material accounting for 0.0005% to 0.099% by weight of the total components, and the carbon material is selected from the group consisting of single-walled carbon nanotubes, multi-walled carbon nanotubes, graphene, graphene oxide and combinations thereof; and a filler accounting for 10% to 75% by weight of the total components, and the filler is selected from the group consisting of carbon black, white smoke, carbon fiber, glass fiber, and combinations thereof.

The present invention further provides an elastic composite material, comprising a silicone rubber; a carbon material accounting for 0.0005% to 0.099% by weight of the total components, and the carbon material is selected from the group consisting of single-walled carbon nanotubes, multi-walled carbon nanotubes, graphene, graphene oxide and combinations thereof; a filler accounting for 10% to 75% by weight of the total components, and the filler is selected from the group consisting of carbon black, white smoke, carbon fiber, glass fiber, and combinations thereof; and a cross-linking agent accounting for 0.5% to 2% by weight of the total components.

The present invention further provides a product, which is produced by the elastic composite material according to the above-mentioned formula, and the product is a tire, tread stock, a shoe sole, a belt, a conveying belt and a floor.

The present invention also provides a tread stock, comprising a silicone rubber and a carbon material which is dispersed in the silicone rubber and accounts for 0.0005% to 0.099% by weight of the total components, and the carbon material is selected from the group consisting of single-walled carbon nanotubes, multi-walled carbon nanotubes, graphene, graphene oxide and combinations thereof; as well as a filler accounting for 10% to 75% by weight of the total components, and the filler is selected from the group consisting of carbon black, white smoke, carbon fiber, glass fiber, and combinations thereof.

Thus, compared with the conventional silicone rubber products, the product produced by the formula of the present invention at least has the following advantages:

1. The product produced with the formula for producing the elastic composite material of the present invention, such as the tire, the tread stock, the shoe sole, the belt, the conveying belt and the floor, is more abrasion-resistant and more aging-resistant, thereby prolonging the lifetime of the product.

2. As for the product produced with the formula for producing the elastic composite material of the present invention, such as the tire, the tread stock, the shoe sole, the belt, the conveying belt and the floor, due to the increases in abrasion resistance and aging resistance, compared with the conventional silicone rubber products, the total amount of the elastic composite material of the product of the present invention can be further reduced, and not only the production cost, but also the weight of the product can be effectively reduced.

3. As for the product produced with the formula for producing the elastic composite material of the present invention, for example, when being applied to the tire, the tread stock, the belt and the like, after testing, it is found that the temperature rise in dynamic deformation may be reduced, so that the product is particularly suitable for being used as the tread stock in the tire. This is because that the tread stock is a layer of rubber which is on the outermost layer of the tire, in contact with the road surface and printed with a tread pattern. This not only allows the tire to have tractive force, but also has the capability of cushioning the impact and the sway extent of a vehicle in the driving process. In view of the fact that the elastic composite material produced according to the formula of the present invention has improved abrasion resistance, when it is applied to the tread stock, it will have more advantages than the conventional materials.

### DETAILED DESCRIPTION OF THE PREFERRED EMBODIMENTS

The detailed description and technical content of the present invention are described below in conjunction with the embodiments.

The elastic composite material of the present invention mainly comprises a silicone rubber and a carbon material dispersed in the silicone rubber.

In one embodiment of the present invention, the silicone rubber may be any one of various conventional types of silica gel or rubber and may be selected by one of ordinary skill in the art according to the properties and the type of the product to be produced without particular limitation.

The carbon material may be single-walled carbon nanotubes, multi-walled carbon nanotubes, graphene, graphene oxide or combinations thereof, and the carbon material accounts for 0.0005% to 0.099%, preferably 0.005% to 0.05%, and more preferably 0.0005% to 0.02%, by weight of the total components.

The present invention further provides an elastic composite material, mainly comprising a silicone rubber, a carbon material dispersed in the silicone rubber and a filler, wherein the silicone rubber may be any one of various conventional types of silica gel or rubber; the carbon material accounts for 0.0005% to 0.099% by weight of the total components, and may be single-walled carbon nanotubes, multi-walled carbon nanotubes, graphene, graphene oxide or combinations thereof; and the filler accounts for 10% to 75% by weight of the total components, and may be selected from the group consisting of carbon black, white smoke, carbon fiber, glass fiber, and combinations thereof.

In one embodiment of the present invention, the foregoing elastic composite material is produced by the following formula, and the formula mainly comprises a silicone rubber, a carbon material, a filler and a cross-linking agent.

In one embodiment of the present invention, the foregoing silicone rubber may be any one of various conventional types of silica gel or rubber which may be selected by one of ordinary skill in the art according to the properties and the type of the product to be produced without particular limitation.

In one embodiment of the present invention, the carbon material is single-walled carbon nanotubes, multi-walled carbon nanotubes, graphene, graphene oxide or combinations thereof, and the carbon material accounts for 0.0005% to 0.099%, preferably 0.005% to 0.05%, and more preferably 0.0005% to 0.02%, by weight of the total components.

The filler may be selected from the group consisting of carbon black, white smoke, carbon fiber, glass fiber, and combinations thereof, and in one preferred embodiment of the present invention, the filler accounts for 10% to 75%, preferably 25% to 50%, by weight of the total components.

The cross-linking agents applicable to the present invention include, but are not limited to, sulfocompounds (such as sulfur), peroxides, metallic oxides, ester chemical compounds, amine chemical compounds, resin chemical compounds, selenium or tellurium, as long as the cross-linking agent may perform chemical reaction with rubber molecules at high temperature of about 150° C. to 195° C. to form a three-dimensional reticular structure. Furthermore, in one embodiment of the present invention, the cross-linking agent accounts for 0.5% to 2% by weight of the total components.

In addition to the above-mentioned cross-linking agent, an additive may be further added for the purposes of softening, plasticization, lubrication and the like. The additive applicable to the present invention may be zinc-oxide powder (such as zinc oxide), stearic acid, oil or a thiazole type and a sulfonamide type accelerator and can be selected by one of ordinary skill in the art according to the demands without particular limitation in the present invention.

With respect to the adding ratio of the additive, there is no particular limitation in the present invention. In one non-limiting embodiment, the zinc-oxide powder may account for 0.00001% to 3% by weight of the total components, the stearic acid may account for 0.00001% to 2% by weight of the total components, the oil may account for 0.00001% to 18% by weight of the components, and the accelerator can account for 0.00001% to 2% by weight of the components.

As for the method for preparing the elastic composite material, there is no particular limitation in the present invention. For example, the silicone rubber may be prepared first, then the carbon material is added into the silicone rubber to uniformly disperse the carbon material in the silicone rubber to form a mixed compound comprising the carbon material, then the mixed compound, the filler and the cross-linking agent are mixed together and heated to, such as, about 150° C. to 180° C. for hardening, and after that, the elastic composite material is able to be obtained.

As for the above-mentioned method of ‘uniformly dispersing the carbon material in the silicone rubber’, for example, a double-roller mixing mill, a kneader and a banbury for dispersion may be used for dispersion. However, as long as the carbon material is able to be actually dispersed, there is no particular limitation in the present invention.

Hereinafter, the elastic composite materials of Embodiment 1, Embodiment 2, Embodiment 3, Comparative Embodiment 1, Comparative Embodiment 2 and Comparative Embodiment 3 were manufactured according to the different formulas in Table 1 below respectively for subsequent physical tests.

TABLE 1
(unit: percentage % by weight)

| | | | | Comparative | Comparative | Comparative |
|---|---|---|---|---|---|---|
| | Embodiment 1 | Embodiment 2 | Embodiment 3 | Embodiment 1 | Embodiment 2 | Embodiment 3 |
| Oil-filled | 44.71 | 44.71 | 0.00 | 44.72 | 44.67 | 0.00 |
| styrene | | | | | | |
| butadiene | | | | | | |
| rubber | | | | | | |
| (SBR1712) | | | | | | |
| Butadiene | 10.27 | 10.27 | 0.00 | 10.27 | 10.26 | 0.00 |
| rubber | | | | | | |
| (BR) | | | | | | |
| Styrene | 0.00 | 0.00 | 62.22 | 0.00 | 0.00 | 62.22 |
| butadiene | | | | | | |
| rubber | | | | | | |
| (SBR) | | | | | | |
| Carbon | 36.37 | 36.36 | 31.11 | 36.37 | 36.33 | 31.12 |
| black | | | | | | |
| Zinc-oxide | 1.28 | 1.28 | 1.87 | 1.28 | 1.28 | 1.87 |
| powder | | | | | | |
| Stearic | 0.43 | 0.43 | 0.62 | 0.43 | 0.43 | 0.62 |
| acid | | | | | | |
| Oil | 5.35 | 5.35 | 1.86 | 5.35 | 5.34 | 1.87 |
| Accelerator | 0.73 | 0.73 | 1.06 | 0.73 | 0.73 | 1.06 |
| Sulfur | 0.86 | 0.86 | 1.24 | 0.86 | 0.85 | 1.24 |
| Carbon | 0.01 | 0.02 | 0.02 | 0.00 | 0.11 | 0.00 |
| nanotubes | | | | | | |

The compositions of Embodiment 1, Embodiment 2, Comparative Embodiment 1 and Comparative Embodiment 2 in Table 1 are mainly different in the ratio of the carbon nanotubes. The supplementary explanation is that the oil in Table 1 may be any applicable rubber processing oil, such as cycloalkyl processing oil, paraffin-based processing oil, aromatic-base processing oil and the like, which is used as a compound for the purpose of softening the rubber; and the accelerator may be 1,3-diphenylguanidine, N-cyclohexyl-2-benzothiazolesulfenamide and 2-(morpholinothio)-benzothiazole.

In addition, the oil-filled styrene butadiene rubber (SBR1712), the styrene-butadiene rubber (SBR), the butadiene rubber (BR) or a mixture thereof is the silicone rubber in the above-mentioned manner, and the oil-filled styrene-butadiene rubber (SBR1712) is a styrene butadiene rubber (SBR) including the added oil.

Next, the elastic composite materials of Embodiment 1, Embodiment 2, Comparative Embodiment 1 and Comparative Embodiment 2 were tested for tensile properties and tensile properties after aging, and the results are shown in Table 2 and Table 3 below respectively.

TABLE 2

| | Embodi- | Embodi- | Comparative | Comparative |
|---|---|---|---|---|
| | ment 1 | ment 2 | Embodiment 1 | Embodiment 2 |
| Hardness | 68 | 68 | 68 | 66 |
| Tensile | 203 | 198 | 210 | 195 |
| strength | | | | |
| (kg/cm²) | | | | |
| Tensile ratio | 529 | 529 | 524 | 690 |
| (%) | | | | |
| 300% M | 100 | 99 | 105 | 68 |
| (kg/cm²) | | | | |
| Tear strength | 36 | 41 | 34 | 33 |
| (kg/cm) | | | | |

TABLE 3

| | Embodi- | Embodi- | Comparative | Comparative |
|---|---|---|---|---|
| | ment 1 | ment 2 | Embodiment 1 | Embodiment 2 |
| Hardness | 74 | 74 | 74 | 71 |
| Tensile | 185 | 191 | 186 | 186 |
| strength | | | | |
| (kg/cm²) | | | | |
| Tensile ratio | 395 | 415 | 390 | 530 |
| % | | | | |
| 300% M | 137 | 137 | 143 | 95 |
| (kg/cm²) | | | | |
| Tear strength | 20 | 31 | 20 | 28 |
| (kg/cm) | | | | |
| Retention rate | 91.13% | 96.46% | 88.57% | 95.36% |
| of tensile | | | | |
| strength | | | | |
| Retention rate | 74.67% | 78.45% | 74.43% | 76.81% |
| of Tensile ratio | | | | |
| % | | | | |
| Akron | 257 | 177 | 100 | 30 |
| abrasion test | | | | |

In Table 2 and Table 3, the tensile properties are the test results of the elastic composite materials after testing at 165° C. for 15 minutes and then placing at room temperature for 16 hours; and the tensile properties after aging are the test results of the elastic composite materials after testing at 165° C. for 15 minutes, then placing at room temperature for 16 hours and further processing at 100° C. for 48 hours. The supplementary explanation is that the ‘300% M’ in Table 2 and Table 3 are stress values at the tensile ratio of 300%, and the higher the value is, the more rigid the material is.

The above-mentioned elastic composite materials of Embodiment 1, Embodiment 2, Comparative Embodiment 1 and Comparative Embodiment 2 were also subjected to the Akron abrasion test to confirm the abrasion resistance. The test pieces were tested at 165° C. for 15 minutes and then placed at room temperature for 16 hours for obtaining the test results.

The Akron abrasion test showed that, the abrasion index of Embodiment 1 was 257, the abrasion index of Embodiment 2 was 177, both of which were better than the abrasion index of 100 of Comparative Embodiment 1 which was not added with the carbon nanotubes; in addition, the abrasion indexes of Embodiment 1 and Embodiment 2 were also better than Comparative Embodiment 2 with the adding amount of the carbon nanotubes in the range of 0.0005% to 0.099% as defined in the present invention, and in the Comparative Embodiment 2, the abrasion index was measured to be only 30. Therefore, through the Akron abrasion test, it is able to be confirmed that the adding amount of the carbon material needs to be in the range of 0.0005% to 0.099% by weight of the total components so as to obtain the elastic composite material with better effects.

By synthesizing Table 2 and Table 3 above, it is apparent that the elastic composite material prepared by the formula for producing the elastic composite material according to the present invention may exhibit more excellent results of the Akron abrasion test without losing the basic mechanical properties. Furthermore, due to the enhanced abrasion resistance, the lifetime of the elastic composite material prepared by the formula for producing the elastic composite material according to the present invention may be prolonged lifetime of the product during the use.

Further, through Embodiment 3 and Comparative Embodiment 3, the elastic composite materials were produced for a heat generation test respectively, and the test results are shown in Table 4 below.

TABLE 4

| | | Comparative |
|---|---|---|
| | Embodiment 3 | Embodiment 3 |
| Compression ratio (%) | 26.30 | 24.80 |
| Increased temperature (° C.) | 48.5 | 50.7 |

The specific implementation way of the heat generation test in this embodiment was that the testing was performed according to the conditions as defined in ASTM D623. The elastic composite materials were tested at 165° C. for 15 minutes and then placed at room temperature for 16 hours for obtaining the test results. The difference between Embodiment 3 and Comparative Embodiment 3 was whether the carbon material (namely, the carbon nanotubes) was added in the formula or not. As shown in Table 4, compared with Comparative Embodiment 3, the elastic composite material of Embodiment 3 may reduce the temperature by 4.3% in comparison with the data of 50.7° C. of the test piece which was not added with the carbon nanotubes. Therefore, the product produced by the elastic composite material of the present invention is actually effectively reduce the temperature rise in dynamic deformation, is applicable to tires, belts and other products, and may be more energy-efficient during the use.

In summary, compared with the conventional silicon rubber products, the product produced by the elastic composite material of the present invention at least has the following advantages:

1. The product produced with the formula for producing the elastic composite material of the present invention, such as the tire, the shoe sole, the belt, the conveying belt and the floor, is more abrasion-resistant and more aging-resistant, thereby prolonging the lifetime of the product.

2. As for the product produced with the formula for producing the elastic composite material of the present invention, such as the tire, the shoe sole, the belt, the conveying belt and the floor. Because of the increases in abrasion resistance and aging resistance compared with the conventional silicone rubber products, the total amount of the elastic composite material of the product of the present invention may be further reduced, and not only the production cost, but also the weight of the product may be effectively reduced.

3. As for the product produced with the formula for producing the elastic composite material of the present invention, for example, when being applied to the tire, the belt and the like, after testing, it is found that the temperature rise in dynamic deformation may be reduced, so that the product is particularly suitable for being used as the tread stock in the tire. This is because that the tread stock is a layer of rubber which is on the outermost layer of the tire, in contact with the road surface and printed with a tread pattern. This not only allows the tire to have tractive force, but also has the capability of cushioning the impact and the sway extent of a vehicle in the driving process. In view of the fact that the elastic composite material produced according to the formula of the present invention has improved abrasion resistance, when it is applied to the tread stock, it will have more advantages than the conventional materials.

What is claimed is:

1. A formula for producing tread stock, comprising:
a silicone rubber;
a carbon material accounting for 0.005% to 0.02% by weight of total components, wherein the carbon material is selected from the group consisting of single-walled carbon nanotubes, multi-walled carbon nanotubes, graphene, graphene oxide and combinations thereof;
a filler accounting for 10% to 75% by weight of the total components, wherein the filler is selected from the group consisting of carbon black, white smoke, carbon fiber, glass fiber, and combinations thereof; and
a cross-linking agent accounting for 0.5% to 2% by weight of the total components.

2. The formula for producing tread stock according to claim 1, further comprising zinc-oxide powder accounting for 0.00001% to 3% by weight of the total components.

3. The formula for producing tread stock according to claim 1, further comprising stearic acid accounting for 0.00001% to 2% by weight of the total components.

4. The formula for producing tread stock according to claim 1, further comprising oil accounting for 0.00001% to 18% by weight of the total components.

5. The formula for producing tread stock according to claim 1, further comprising an accelerator accounting for 0.00001% to 2% by weight of the total components.
